(19) United States
(12) Patent Application Publication
(10) Pub. No.: US 2010/0166265 A1
(43) Pub. Date: Jul. 1, 2010

(54) Method of Eyelash Removal for Human Iris Recognition

(76) Inventor: Donald Martin Monro, Beckington (GB)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(21) Appl. No.: 12/377,093

(22) PCT Filed: Jul. 4, 2007
(86) PCT No.: PCT/GB07/02500

§ 371 Date: Feb. 10, 2009

(30) Foreign Application Priority Data
Aug. 15, 2006 (GB) 0616222.6

(51) Int. Cl. G06K 9/46

(52) U.S. Cl. 382/117; 382/190

(57) ABSTRACT

A method of pre-processing an image of an iris (114) partly occluded by eyelashes (116, 118) includes the steps of determining a predominant orientation at a local area (120) and identifying a feature representative of an eyelash, applying a directional filter, and replacing pixels of the feature using information from their non-occluded neighbours.

The present invention relates to a method for the removal of eyelashes from iris images, and particularly although not exclusively to images of human irises for use in identity verification. The method has particular although not exclusive application in the pre-processing of human iris images in a human iris recognition system.

Iris recognition is gaining acceptance as a robust biometric for high security and large-scale applications. As with other pattern recognition systems, a typical iris recognition system includes iris capture, image pre-processing, feature extraction and matching. While early work has focused primarily on feature extraction with great success, the pre-processing task has received less attention. However, the performance of a system is greatly influenced by the quality of captured images. Amongst the various factors that could affect the quality of iris images, one of the most commonly encountered is eyelash occlusion, which can degrade iris images either during enrolment or verification. Strong ‘eyelash textures’ obscure the real iris texture, and may interfere seriously with the recognition capability of any recognition system. Reducing the influence of the eyelash on recognition is therefore an important problem.

A method of processing an image of an iris comprising:
a) at a local area of the image, determining a predominant orientation of structure and identifying a feature representative of an eyelash;
b) applying a directional filter in a direction determined by the said orientation to generate a filtered image fragment; and
c) replacing the feature with the image fragment.

The invention further extends to a method of iris recognition, using any convenient algorithm, including the step of pre-processing the image using the above method.

Preferably iris pixels occluded by eyelashes are recreated using information from their non-occluded neighbours. Briefly, for every pixel in the iris image, the method first decides if the pixel is in an area contaminated by eyelashes, and if so determines the direction of the eyelash. It then filters the image locally along a direction perpendicular to the eyelash because there is the best change of finding uncontaminated pixels along this direction. To avoid incorrectly filtering non-eyelash pixels, no pixel is altered unless the change in that pixel exceeds a certain threshold.

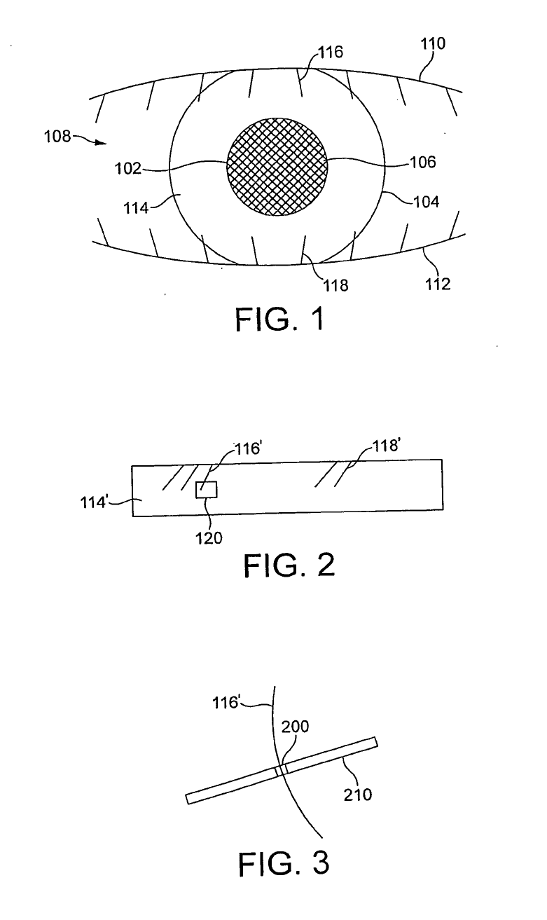

A typical image of a human eye is shown schematically in FIG. 1. In an iris recognition system, this will normally be the initial input, and pre-processing is necessary to eliminate unnecessary information before iris recognition algorithms can be applied. First, inner 102 and outer 104, iris boundaries are located in order to eliminate the pupil 106, sclera 108, and the upper and lower eyelids 110, 112. The remaining part of the image, namely that of the annular iris 114, is in typically transformed from polar coordinance into a rectangular image as shown in FIG. 2.

In FIG. 2, the remapped iris 114′ displays texture (not shown) which is unique to the individual. However, where eyelashes 116, 118 partly overlay the iris, as shown in FIG. 1, the resultant rectangular image will be partly occluded by dark lines 116′, 118′.

Early efforts to mitigate the effects of eyelash tried to ignore parts of the iris to avoid eyelash contamination (see for example L. Ma, T; Tan, Y. Wang, and D. Zhang, “Efficient iris recognition of iris recognition key local variations,” IEEE Trans. On Image Processing, vol. 13, pp. 739-750, 2004; and D. M. Monro and D. Zhang, “An effective human iris code with low complexity,” Proc. IEEE International Conference on Image Processing (ICIP), Genoa, 2005). Later some researchers tried to detect and mask the eyelash pixels from the image (see D. Zhang, “Detecting eyelash and reflection for accurate iris segmentation”, International Journal of Pattern Recognition and Artificial Intelligence, vol. 1, No. 6, pp. 1025-1034, 2003). Zhang et. Al. classified the eyelashes into two categories, separable and multiple. They then used an edge detector to find separable eyelashes, and recognized multiple eyelashes by intensity variance. Another approach is due to Daugman: (see J. Daugman, “The importance of being random: Statistical principles of iris recognition,” Pattern Recognition, vol. 36, pp. 279-291, 2003). Daugman uses wavelet demodulation and masks them in iris coding. Both of these methods locate the eyelash pixels in the image and exclude the iris code bits generated from these pixels. Although these methods successfully detect and mask eyelashes, the improvements in system performance are quite modest.

The invention may be carried into practice in a variety of ways and one specific embodiment will now be described, by way of example, with reference to the accompanying drawings, in which:

FIG. 1 shows a schematic image of the human eye;

FIG. 2 shows the remapped iris, with eyelash occlusions; and

FIG. 3 shows the application of a filter in accordance with an embodiment of the invention.

Briefly, the method proceeds by looking at a small local area 120 of the remapped iris 114′, checking whether any of the pixels within that area are representative of an eyelash and, if so, replacing those pixels with values derived from the non-occluded pixels on either side of the eyelash. The procedure is repeated for all areas 120 across the iris.

In more detail, the procedure consists of the following steps, these being repeated for each local area 120:
1. Determine the predominant direction of the detail/texture which occurs within the local area 120;
2. Determine whether the direction of detail is representative of an eyelash. If so, proceed to step 3; if not, make no changes to the local area 120 and start again at step 1 for the next local area; and
3. Attempt to replace the eyelash pixels within the local area using a local filter.

Typically, the pixels which are representative of the eyelash will be darker than the pixels on either side, and may conveniently be replaced with some suitable averaged value based upon the nearby non-occluded pixels. The proposed replacement pixel values may be subject to a variety of tests, for example to ensure that lighter pixels are never replaced by darker pixels, with the proposed replacements being rejected if the tests are not satisfied. In that event, the algorithm then makes no changes within the current local area 120, and simply moves on to consider the next local area.

The first step in the procedure, to estimate the predominant direction of the detail/texture within the iris, may conveniently be carried out using a Sobel filter. Alternatively, other directional filters such as a local Fourier transform could be used. Another possibility would be to project the data into a variety of directions, and to carry out a summation for each direction.

At step 2, an edge detection algorithm, such as a Sobel filter, is used to decide whether an eyelash is actually present. Any convenient algorithm can be used, but one particularly convenient method is set out below.

An eyelash causes a discontinuity along its edges, so to detect an eyelash and estimate its direction, a 3×3 Sobel edge filter is applied to the normalized image, as follows:

$${\begin{matrix}- 1 & - 2 & - 1 \\ 0 & 0 & 0 \\ 1 & 2 & 1\end{matrix}}_{X Derivative} {\begin{matrix}{Z}_{1} & {Z}_{2} & {Z}_{3} \\ {Z}_{4} & {Z}_{5} & {Z}_{6} \\ {Z}_{7} & {Z}_{8} & {Z}_{9}\end{matrix}}_{Image Region} {\begin{matrix}- 1 & 0 & 1 \\ - 2 & 0 & 2 \\ - 1 & 0 & 1\end{matrix}}_{Y Derivative}$$

For every pixel, the estimated gradients in the X and Y directions are [Gₓ, G_{y}] and the magnitude of the gradient at the centre point of the mask, called Grad, are computed:

Gₓ=(z₇+2z₈+z₉)−(z₁+2z₂+z₃)

G_{y}=(z₃+2z₆+z₉)−(z₁+2z₄+z₇)

Grad=(Gₓ²+G_{y}²)^{1/2}

The local gradient direction (perpendicular to the edge) is:

θ=arctan(G_{y}/Gₓ)

To decide if a pixel is occluded, a window of size [m n] centred at the pixel is taken and a gradient direction variance Var_Grad is computed over those r pixels for which Grad>Grad_Thresh.

$$Var\_Grad = \frac{1}{r - 1} {\sum }_{i = 1}^{r} {( {θ}_{i} - \overline{θ} )}^{2}$$

and Grad_Thresh is a threshold determined by experience for which one choice may be 15.

If the gradient direction has a small variance, less than Var_Grad_Thresh, a strong edge is indicated, and this pixel is classified as being affected by eyelash.

Once a small block of pixels within the local region 120 has been identified as candidates for replacement, a local filter is then used to determine the replacement values. As shown in FIG. 3, a narrow region 210 is defined, this region being perpendicular to the eyelash 116′, and centred on the eyelash pixel or pixels 200 for replacement. Subject to a variety of tests (described below) the pixels 200 are then replaced within the image by some average values which are determined by the values of the pixels on either side, within the region 210. This could be done in any convenient way, for example by replacing the pixels 210 with the mean value of the pixels in the two wings, or alternatively replacing them with the lightest of the pixels within the two wings.

In the preferred embodiment, the following approach is used.

For each pixel classified as an eyelash pixel, a 1D elongate median filter is applied along the direction θ, to estimate the value of the image with the eyelash removed. In general the direction does not pass exactly through pixels, so the median filter is applied to values equally spaced by the distance between actual pixels, which are calculated using bilinear interpolation of the four nearest pixels.

Not every pixel in the eyelash window is occluded by eyelash. The intensity is charged only if the intensity difference exceeds a threshold related to the total variance of the image. Specifically:

Recover=Diff−k*Var(Image)

where Diff is the difference in intensity between the filtered and unfiltered pixel and Var(Image) is the intensity variance of the whole (unfiltered) image. K is the parameter used to tune the threshold. If Recover is positive, the pixel is replaced by the filtered value, otherwise the filter is not applied.

As mentioned above, a variety of tests may be applied to ensure that the proposed pixel replacement value looks reasonable. For example, since eyelashes are typically darker than the iris itself, any proposed change that replaces lighter pixel with a darker pixel is rejected. To prevent the algorithm making a large number of minor changes, a threshold may be imposed whereby in order to be accepted the replacement pixel has to be considerably lighter (not just slightly lighter) than the original.

In the preferred embodiment there are six parameters which affect the performance of the directional filter: the X and Y dimensions of the local area 120, the length of the median filter 210, the pixel threshold Grad_Thresh used in computing Var_Grad, the threshold in the normalised edge point gradient direction variance Var_Grad_Thresh, and the threshold change in pixel value for acceptance. Each of these may be manually tuned, as required, depending on the needs of the particular application. Alternatively, the parameters may be tuned automatically by experimentally determining the values which give the greatest increase in performance when the method is used as a pre-processing step of an existing iris recognition algorithm. Typical algorithms with which the present method may be used, include those of Daugman, Tan, and Monro (Op Cit). Experiments show that the present method can increase the iris matching performance of all three recognition algorithms.

1. A method of processing an image of an iris comprising the steps of:
a) at a local area of the image, determining a predominant orientation of structure and identifying a feature representative of an eyelash;
b) applying a directional filter in a direction determined by the said orientation to generate a filtered image fragment; and
c) replacing the feature with the image fragment.

2. A method as claimed in claim 1 in which the directional filter extends across an elongate window centred on the feature and perpendicular to the predominant orientation at the local area.

3. A method as claimed in claim 1 in which the filtered image fragment is determined in dependence upon the values of pixels on opposing sides of the feature.

4. A method as claimed in claim 3 in which the filtered image fragment is determined by median filtering pixels on opposing sides of the feature.

5. A method as claimed in claim 1 further including the step of identifying a feature representative of an eyelash using a Sobel filter.

6. A method as claimed in claim 1 in which the feature is replaced only if an intensity of the image fragment exceeds an intensity of the feature by more than a threshold value.

7. A method as claimed in claim 6 in which the threshold value is determined as a function of a total variance of the image.

8. A method as claimed in claim 1 in which the replacement is carried out pixel by pixel.

9. A method as claimed in claim 1 in which the replacement is carried out on a block of pixels.

10. A method of iris recognition including pre-processing the image by a method as claimed in claim 1 prior to recognition.
